(19) United States
(12) Patent Application Publication
(10) Pub. No.: US 2022/0343218 A1
(43) Pub. Date: Oct. 27, 2022

(54) Input-Encoding with Federated Learning

(71) Applicant: International Business Machines Corporation, Armonk, NY (US)

(72) Inventors: Hazar Yueksel, New York, NY (US); Brian E. D. Kingsbury, Cortlandt Manor, NY (US); Kush Raj Varshney, Ossining, NY (US); Pradip Bose, YORKTOWN HEIGHTS, NY (US); Dinesh C. Verma, New Castle, NY (US); Shiqiang Wang, White Plains, NY (US); Augusto Vega, Mount Vernon, NY (US); ASHISH VERMA, Nanuet, NY (US); SUPRIYO CHAKRABORTY, White Plains, NY (US)

(73) Assignee: International Business Machines Corporation, Armonk, NY (US)

(21) Appl. No.: 17/239,812

(22) Filed: Apr. 26, 2021

(51) Int. Cl. G06N 20/20; G06F 11/34

(52) U.S. Cl. CPC G06N 20/20; G06F 11/3466

(57) ABSTRACT

Embodiments relate to an input-encoding technique in conjunction with federation. Participating entities are arranged in a collaborative relationship. Each participating entity trains a machine learning model with an encoder on a training data set. The performance of each of the models is measured and at least one of the models is selectively identified based on the measured performance. An encoder of the selectively identified machine learning model is shared with each of the participating entities. The shared encoder is configured to be applied by the participating entities to train the first and second machine learning models, which are configured to be merged and shared in the federated learning environment.

### BACKGROUND

The present embodiments relate to training a machine learning model through a collaborative process. More specifically, the embodiments relate to techniques for applying an input encoding method in federated learning.

Artificial Intelligence (AI) relates to the field of computer science directed at computers and computer behavior as related to humans. AI refers to the intelligence when machines, based on information, are able to make decisions, which maximize the chance of success in a given topic. More specifically, AI is able to learn from a data set to solve problems and provide relevant recommendations. For example, in the field of artificially intelligent computer systems, natural language systems (such as the IBM Watson® artificially intelligent computer system or other natural language interrogatory answering systems) process natural language based on system acquired knowledge. To process natural language, the system may be trained with data derived from a database or corpus of knowledge, but the resulting outcome can be incorrect or inaccurate for a variety of reasons.

Machine learning (ML), which is a subset of Artificial intelligence (AI), utilizes algorithms to learn from data and create foresights based on this data. ML is the application of AI through creation of models, including neural networks that can demonstrate learning behavior by performing tasks that are not explicitly programmed. ML workloads require large data sets, fast and parallel access to the data, and algorithms for training to support leanings. Training AI models depends on large and high-quality datasets. In enterprises, this data may be spread across different entities and data centers, making it challenging to combine and analyze. Bringing data together to a single repository for training is often not possible or practical.

Federated learning is a distributed machine learning process in which different parties, e.g. clients, collaborate to jointly train a machine learning model without the need to share training data with the other parties. Each client has access to only their data. As such, the data is not independent and identically distributed across the clients.

### SUMMARY

The embodiments include a system, computer program product, and method for secured federated machine learning.

In one aspect, a system is provided for use with an artificial intelligence (AI) platform to train a machine learning model through a collaborative process. The processing unit is operatively coupled to the memory and is in communication with the AI platform, which is embedded with tools in the form of a registration manager, an evaluator, and a director. The registration manager functions to arrange first and second participating entities in a collaborative relationship. The first participating entity trains a first machine learning model with a first encoder on a first training data set and the second participating entity trains a second machine learning model with a second encoder on a second training data set. The evaluator, which is operatively coupled to the registration manager, functions to measure performance of the first and second machine learning models and selectively identify at least one of the first and second machine learning models based on the measured performance. The director, which is operatively coupled to the evaluator, functions to share an encoder of the selectively identified machine learning model with each of the participating entities. The shared encoder is configured to be applied by the first and second participating entities to train the first and second machine learning models, respectively. The director is further configured to merge the first and second trained machine learning models and form a single shared model configured to be distributed to the participating entities.

In another aspect, a computer program product is provided to train a machine learning model through a collaborative process. The computer program product includes a computer readable storage medium having program code embodied therewith, with the program code executable by a processor to arrange first and second participating entities in a collaborative relationship. The first participating entity trains a first machine learning model with a first encoder on a first training data set and the second participating entity trains a second machine learning model with a second encoder on a second training data set. The program code functions to measure performance of the first and second machine learning models and selectively identify at least one of the first and second machine learning models based on the measured performance. The program code further functions to share an encoder of the selectively identified machine learning model with each of the participating entities. The shared encoder is configured to be applied by the first and second participating entities to train the first and second machine learning models, respectively. Program code is further configured to merge the first and second trained machine learning models and form a single shared model configured to be distributed to the participating entities.

In yet another aspect, a method is provided for training a machine learning model through a collaborative process. First and second participating entities are arranged in a collaborative relationship. The first participating entity trains a first machine learning model with a first encoder on a first training data set and the second participating entity trains a second machine learning model with a second encoder on a second training data set. The performance of the first and second machine learning models is measured and at least one of the first and second machine learning models is selectively identified based on the measured performance. An encoder of the selectively identified machine learning model is shared with each of the participating entities. The shared encoder is configured to be applied by the first and second participating entities to train the first and second machine learning models, respectively. The first and second trained machine learning models are subject to merging and forming a single shared model configured to be distributed to the participating entities.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a system diagram illustrating a computer system configured for federated learning according to an embodiment.

FIG. 2 depicts a block diagram illustrating participating entities in a star protocol arrangement to support collaboration in a federated learning environment.

FIG. 3 depicts a block diagram illustrating an artificial intelligence platform and tools, as shown and described in FIG. 1, and their associated application program interfaces.

FIGS. 4A and 4B depict a flow chart illustrating an embodiment of a method involving sharing of models and corresponding encoders with an operatively coupled entity.

FIG. 5 depicts a flow chart illustrating an embodiment of a method involving selection of two or more encoders based on the performance assessment from the test data.

FIG. 6 depicts a flow chart illustrating an embodiment of a method involving creating a union of encoders for use in the federated learning.

FIG. 7 depicts a flow chart illustrating an embodiment of a method involving conducting performance assessment in a distributed manner.

FIG. 8 depicts a block diagram illustrating an example of a computer system/server of a cloud based support system, to implement the system and processes described above with respect to FIGS. 1-7.

FIG. 9 depicts a block diagram illustrating a cloud computer environment.

FIG. 10 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Neural networks are models of the way the human brain processes information. Basic units of the neural networks are referred to as neurons, which are typically organized into layers. The neural network works by simulating a large number of interconnected processing units that resemble abstract versions of neurons. There are typically three parts in a neural network, including an input layer, with units representing input fields, one or more hidden layers, and an output layer, with a unit or units representing target field(s). The units are connected with varying connection strengths or weights. Input data is presented to the first layer, and values are propagated from each neuron to every neuron in the next layer. Eventually, a result is delivered from the output layers. Deep learning complex neural networks are designed to emulate how the human brain works, so computers can be trained to support poorly defined abstractions and problems. Neural networks and deep learning are often used in image recognition, speech, and computer vision applications.

Neural networks are comprised of interconnected layers and corresponding algorithms and adjustable weights. The weights are subject to adjustment using an optimization algorithm, such as stochastic gradient descent. More specifically, gradient descent is an optimization algorithm used to minimize a function by iteratively moving in a direction of steepest descent as defined by a negative gradient. In ML, gradient descent is used to update parameters of the neural network and a corresponding neural model. This is straightforward when training on a single physical machine, or among computers within a single entity. However, when multiple entities are involved, it can either be impossible to share data due to communication limitations or due to legal reasons (regulations like HIPAA etc.). It is understood in the art that sharing insights from data may lead to building a desirable or improved neural model. However, sharing data leads to other issues, such as confidentiality and privacy breaches due to other participating entities reverse engineering, e.g. reconstructing, data from the shared insights.

As shown and described herein, a system, computer program product, and method, are provided to support and enable multiple client machine collaboration through a central server to train a machine learning model. It is understood in the art of federated learning that each client machine has access to only its own data, and the server only receives model parameters or updates to model parameters from the client machines, thereby ensuring privacy of client machine data. The present embodiments are directed at federated learning in which one or more encoders are identified and distributed. In general, an encoder is a device or process that converts data from one format to another. With respect to machine learning, original input features are encoded from at least one input sample \vec{x}ₛ with a uniquely decodable code using an encoder E(·) to produce encoded input features E(\vec{x}ₛ), wherein the at least one input sample \vec{x}ₛ comprises uncoded input features. The encoder generates the encoded input features, e.g. encodings, from its input features to enable a classifier, C, to learn relations between these features. The uncoded input features and the encoded input features E(\vec{x}ₛ) are fed together to a base model to train an encoded model. A classification function \tilde{C}_{E} (·) is learned using the encoded model, wherein the classification function \tilde{C}_{E} (·) learned using the encoded model is more general than that learned using the uncoded input features alone.

The embodiments are directed at application of an input-encoding technique in conjunction with federated learning, and more specifically, at evaluation and selection of one or more encoders using a trust metric. The selected encoders are shared or otherwise distributed with operatively coupled local entities, e.g. client machines, to enable the local entities to train their local entity model(s), also referred to herein as base model(s), with the training leveraging the selected encoder and local data. Accordingly, the federated learning process herein limits distribution among members of the federated learning environment to the encoders and corresponding models, with the federated learning process enabling local entities to benefit from performance assessment, corresponding encoder selection, and model updates for members of the federated learning system.

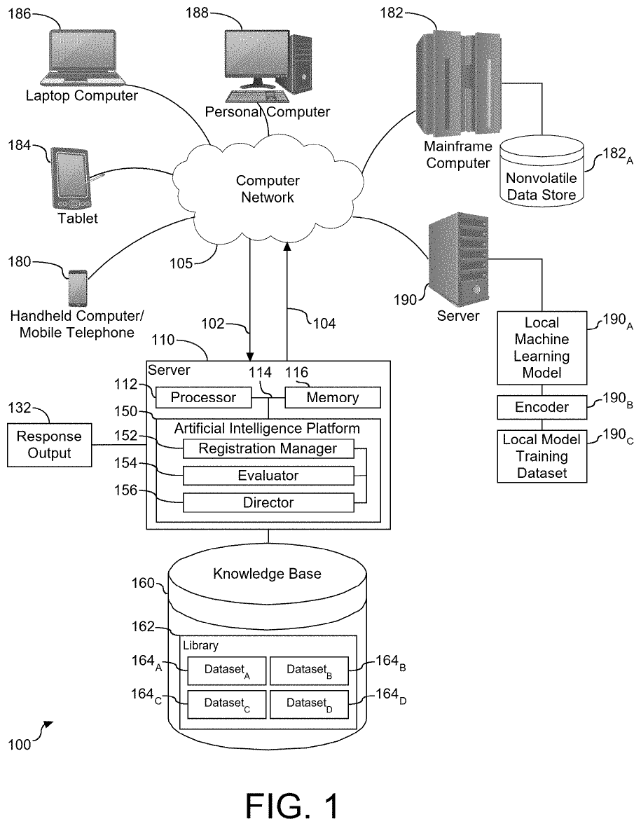

Referring to FIG. 1, a schematic diagram (100) is provided to illustrate a computer system configured for federated learning. As shown, a server (110), also referred to herein as a federated learning server, is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform (150) to support federated learning to selectively identify an encoder in a distributed, federated, private and secure environment. The server (110) is in communication with one or more of the computing devices (180), (182), (184), (186), (188), and (190) over the network (105). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The AI platform (150) is shown herein configured to receive input (102) from various sources. For example, AI platform (150) may receive input from the network (105) and leverage a data source (160), also referred to herein as a corpus or knowledge base, to assess performance of a machine learning model. As shown, the data source (160) is configured with a library (162), or in one embodiment with a plurality of libraries, with the library (162) including one or more datasets, including dataset_{A} (164_{A}), dataset_{B} (164_{B}), dataset_{C} (164_{C}), and dataset_{D} (164_{D}). In one embodiment, the library (162) may include a reduced quantity of datasets or an enlarged quantity of datasets. Similarly, in one embodiment, the libraries in the data source (160) may be organized by common subjects or themes, although this is not a requirement.

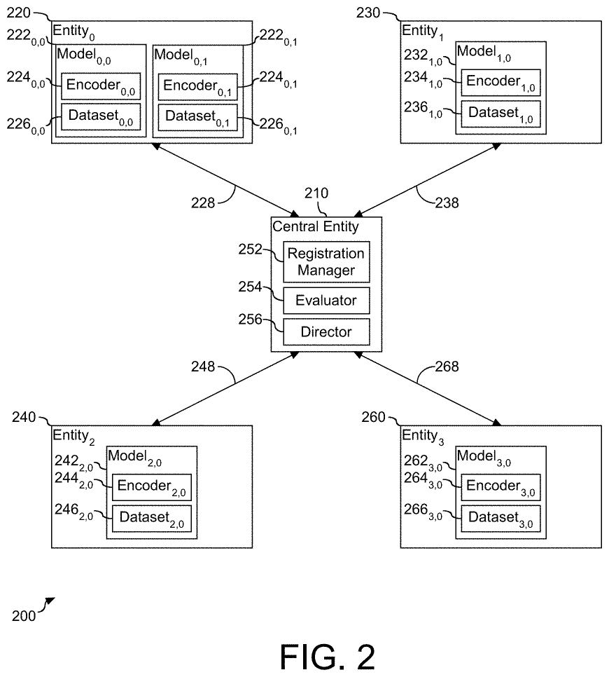

The AI platform (150) is provided with tools to support and enable machine learning collaboration. The various computing devices (180), (182), (184), (186), (188), and (190) in communication with the network (105) may function as local entities with local machine learning models. The AI platform (150) functions as a platform to enable and support collaboration corresponding to the local machine learning models without sharing insights or data. As shown and described herein, the tools in support of the federated learning are local to the AI platform (150). More specifically, as described in detail herein, the AI platform (150) and the corresponding tools enable sharing local encoders and local machine learning models without sharing the data. Response output (132) in the form of an encoder and a corresponding neural model with desired performance or accuracy is obtained and shared with the entities that encompass and participate in the collaboration. In one embodiment, the AI platform (150) communicates the response output (132) to members of a collaborative topology, such as that shown and described in FIG. 2, operatively coupled to the server (110) or one or more of the computing devices (180), (182), (184), (186), (188), and (190) across the network (105).

The network (105) may include local network connections and remote connections in various embodiments, such that the AI platform (150) may operate in environments of any size, including local and global, e.g. the Internet. The AI platform (150) serves as a back-end system to support the collaboration. In this manner, some processes populate the AI platform (150), with the AI platform (150) also including input interfaces to receive requests and respond accordingly.

The AI platform (150) is shown herein with several tools to support neural model collaboration, including a registration manager (152), an evaluator (154), and a director (156). The registration manager (152) functions to register participating entities into a collaborative relationship, including arrangement of the registered entities in a topology, and establishing a communication direction and communication protocol among the entities in the topology. For example, in an embodiment, the registered entities are arranged in a ring topology. However, the communication protocols may vary. Examples of the protocol include, but are not limited to, a linear direction protocol, a broadcast protocol, and an All-Reduce protocol. As further shown and described herein, the entities that are registered members of the collaborative relationship are referred to herein as local entities, and are each operatively coupled to the server (110) across the network connection (105). Each of the entities includes a local machine learning model and a corresponding local encoder, with each local machine learning model trained with a local training dataset. By way of example, computing entity (190) is shown with local machine learning model (192_{A}), a corresponding encoder (192_{B}), and a local model training dataset (192_{C}). Accordingly, the registration manager (152) establishes the arrangement of participating entities in the federated learning environment to support collaboration among the entities.

The evaluator (154), shown herein operatively coupled to the registration manager (152), functions to address performance of the local machine learning models of the participating entities. The evaluator (154) measures performance of each of the registered local models against one or more test datasets, and selectively identifies at least one of the registered local models based on the performance measurement(s). Each registered local model has a corresponding encoder, E(·). The director (156) shares an encoder associated with the selectively identified local model with the participating entities. In an embodiment, the director (156) shares the local model corresponding to the selected or identified encoder with the participating entities. The participating entities receive the identified encoder and/or model, and apply their local data to training their local model(s) based on the shared encoder. After the local models are training on the identified or selected encoder, the corresponding local entities share the trained local models with the AI platform (150), which are then subject to merging by the director (156) to create a single model that is communicated as response output (132) to members of a collaborative topology as single shared model. Accordingly, the sharing among the participating entities is limited to an encoder and trained model parameters or model parameter updates, and in an embodiment an associated machine learning model, thereby supporting the benefit of learning while eliminating sharing of data among the participating entities.

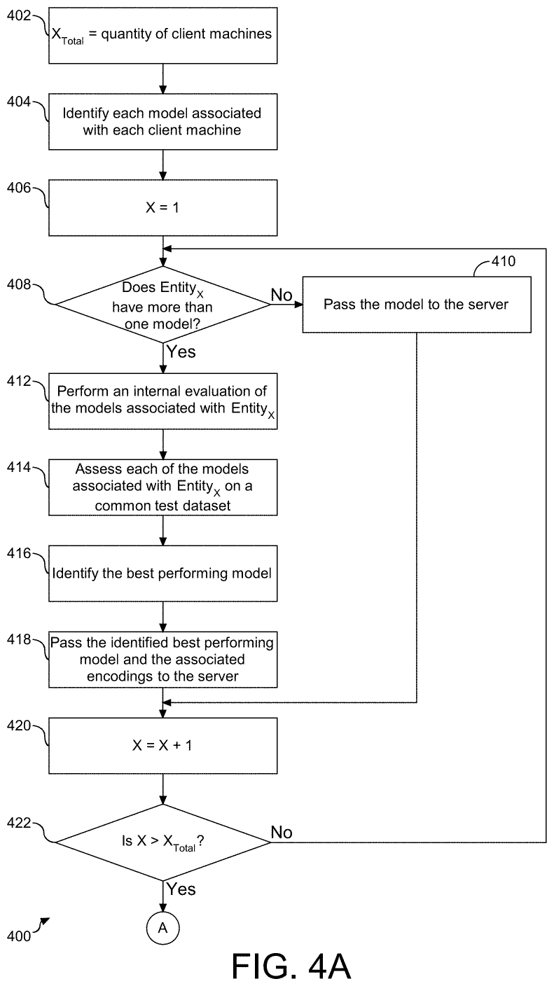

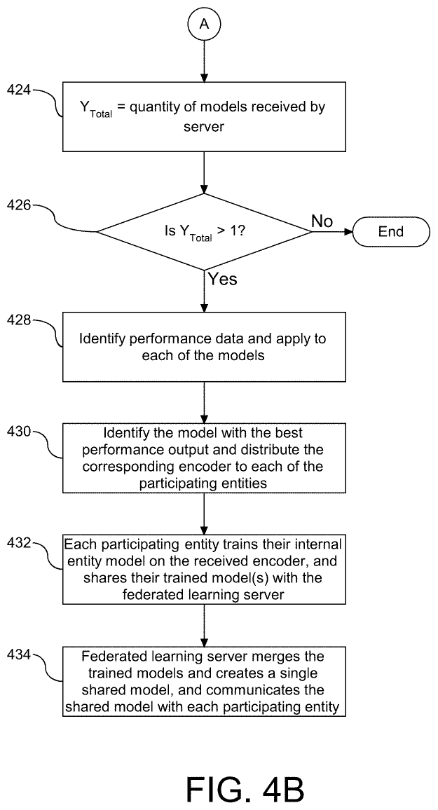

The embodiments shown and described herein may be expanded to address multiple machine learning models and corresponding encoders and data sets local to a participating entity. Referring to FIG. 2, a block diagram (200) is provided to illustrate participating entities in a star protocol arrangement, also referred to herein as a hub and spokes protocol arrangement, to support collaboration. As shown, a central entity (210) is operatively coupled to local entities (220), (230), (240), and (260). The central entity (210) is configured with the tools of the AI platform shown in FIG. 1, including the registration manager (252), evaluator (254), and director (256). Local entity₀ (220) is shown with two machine learning models, shown herein as model_{0,0} (222_{0,0}) and model_{0,1} (222_{0,1}). Model_{0,0} (222_{0,0}) is shown with encoder_{0,0} (224_{0,0}) and dataset_{0,0} (226_{0,0}) and model_{0,1} (222_{0,1}) is shown with encoder_{0,1} (224_{0,1}) and dataset_{1,1} (226_{0,1}). The remaining local entities (230), (240), and (260) are shown with one local model, and an associated encoder and dataset. The quantity of models shown in the local entities is for descriptive purposes, and should not be considered limiting. By way of example, local entity₁ (230) is shown with model_{1,0} (234₀), encoder_{1,0} (234_{1,0}) and dataset_{1,0} (236_{1,0}), local entity₂ (240) is shown with model_{2,0} (242_{2,0}), encoder_{2,0} (244_{2,0}) and dataset_{2,0} (246_{2,0}), and local entity₃ (260) is shown with model_{3,0} (262_{3,0}), encoder_{3,0} (264_{3,0}) and dataset_{3,0} (266_{3,0}). Although only one of the local entities is shown with multiple models, in an exemplary embodiment, one or more additional local entities may be provided with multiple models. Similarly, in an embodiment, the quantity of multiple local models may be greater than that shown. In the embodiment shown and described in FIG. 2, the evaluator (254) functions to measure performance of the local models. In the case of a local entity with multiple local models, such as local entity₀ (220) shown with two machine learning models, e.g. model_{0,0} (222_{0,0}) and model_{0,1} (222_{0,1}), the evaluator (254) measures the performance of each of the learning models for selective identification. The process of model performance assessment is shown and described in FIGS. 4A-7. Accordingly, the participating entities may be configured or provided with multiple local models for participation in the federated learning.

Each entity separately shares their local performance assessment data, as shown and described in FIGS. 4A and 4B, or their encoder and/or model with the central entity (210) across the local communication channel (228), (238), (248), and (268), respectively. The evaluator (254) may selectively identify a single model and corresponding encoder to be shared in the federated learning, or in an exemplary embodiment, the evaluator (254) may selectively identify more than one local model from multiple received local models. In the case of identification of multiple models, the evaluator creates a union of the encoders for the director (256) to share with the participating entities. Accordingly, the server (210), or in the embodiment shown in FIG. 2, the central entity (210), evaluates the local entity models on a common test dataset.

The embodiments shown and described in FIGS. 1 and 2 are directed at the server (110) or the central entity (210) conducting the performance evaluation on a common dataset. In an exemplary embodiment, the performance evaluation may be conducted local to the participating entities, also referred to herein as distributed performance evaluation. Referring to FIG. 2, the central entity (210) by way of the evaluator (254) may support the distributed performance evaluation with the evaluator (254) configured to share the encoder of the local entity model(s) identified through the performance evaluation with each of the participating entities. Following performance evaluation, and identification or selection of one or more encoders, the central entity (210) distributes the identified or selected encoder(s), and in an embodiment the corresponding model, to each of the operatively coupled entities across their respective communication channel. In an embodiment, the central entity (210) receives the encoder and corresponding local entity models from each participating entity, and the evaluator shares the received encoder and corresponding local entity models with each of the participating entities. The distributed performance evaluation is conducted local to each local entity, such that local entity₀ (220) evaluates each of the received local entity models, e.g. model_{1,0} (232_{1,0}), model_{2,0} (242_{2,0}), and model_{3,0} (262_{3,0}) with a local dataset, such as dataset_{0,0} (226_{0,0}). Similar performance evaluations are conducted on each of the received local entity models. For example, local entity₁ (230) conducts a performance evaluation of the received local models with a local dataset, such as dataset_{1,0} (236_{1,0}), local entity₂ (240) conducts a performance evaluation of the received local models with a local dataset, such as dataset_{2,0} (246_{1,0}), and local entity₃ (260) conducts a performance evaluation of the received local models with a local dataset, such as dataset_{3,0} (266_{3,0}). In an embodiment, the local datasets are different, such that dataset_{0,0} (226_{0,0}), dataset_{1,0} (236_{1,0}), dataset_{2,0} (246_{2,0}), and dataset_{3,0} (266_{3,0}) are different datasets. Performance evaluation data from each local entity and each received local entity model is shared with the evaluator (154), (254) for selective identification of one or more of the models. Accordingly, as shown herein, the performance evaluation may be tiered such that one level of the evaluation is conducted on a local level with disparate datasets, and a second level of evaluation is conducted on a central level by the server (110) or the central entity (210).

The registration manager (152) is responsible for establishing the topology and communication protocols. In one embodiment, the registration manager (152) establishes a fully connected topology, also known as a mesh topology, and a corresponding broadcast protocol where each participating entity sends, e.g. broadcasts, their encoders across the topology and directly to every other participating entity in the topology. The evaluator (154) further supports and enables selective model and encoder identification, which may employ a central performance evaluation by the evaluator (154), (254) or distributed performance evaluation by each of the local participating entities. The goal in the performance evaluation is for each participating entity to receive and benefit from one or more selectively identified encoders of the other participating entities. In the star topology, each participating member entity can communicate directly with the AI platform (150), and as such, the evaluator (154) is configured to assess model performance. In an embodiment, one or more of the local entities may be registered but not actively participating with the AI platform (150), in which case the evaluator (154) may limit sharing of the selectively identified encoder(s) with contributing entities, or request an identified non-contributing entity to either broadcast their local model(s) to the server (110) or broadcast their local model(s) to each of the participating members of the topology, depending on the broadcast protocol for performance evaluation. Accordingly, as shown and described herein, the star topology employs a broadcast protocol, and in one embodiment entity participation verification to support the federated machine learning.

In some illustrative embodiments, server (110) may be the IBM Watson® system available from International Business Machines Corporation of Armonk, N.Y., which is augmented with the mechanisms of the illustrative embodiments described hereafter. The IBM Watson® system shown and described herein includes tools to implement federated machine learning based on performance evaluation and associated sharing protocols. The tools enable selective identification and sharing of encoders without sharing the underlying data, thereby enabling the data to remain confidential or private.

The registration manager (152), evaluator (154), and director (156), hereinafter referred to collectively as AI tools or AI platform tools, are shown as being embodied in or integrated within the AI platform (150) of the server (110). The AI tools may be implemented in a separate computing system (e.g., 190) that is connected across network (105) to the server (110). Wherever embodied, the AI tools function to support and enable federated machine learning in an iterative manner, including sharing of the encoders and local models among participating entities, without sharing or disclosing underlying data.

Types of information handling systems that can utilize the AI platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various information handling systems can be networked together using computer network (105). Types of computer networks (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes non-volatile data store (190_{A}), and mainframe computer (182) utilizes nonvolatile data store (182_{A}). The nonvolatile data store (182_{A}) can be a component that is external to the various information handling systems or can be internal to one of the information handling systems.

The information handling system employed to support the AI platform (150) may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, an information handling system need not necessarily embody the north bridge/south bridge controller architecture, as it will be appreciated that other architectures may also be employed.

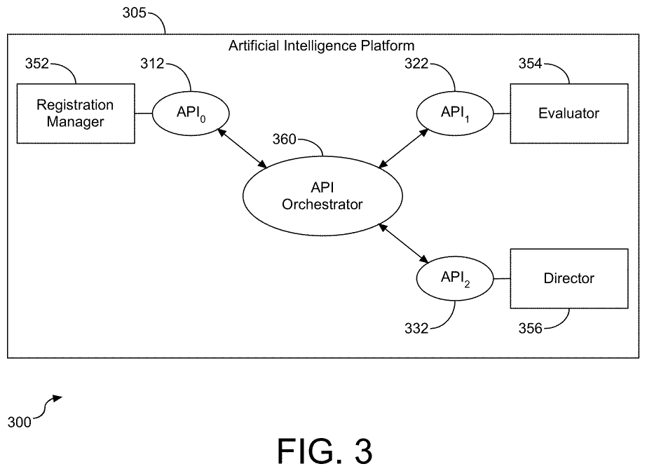

An Application Program Interface (API) is understood in the art as a software intermediary between two or more applications. With respect to the AI platform (150) shown and described in FIG. 1, one or more APIs may be utilized to support one or more of the tools (152)-(156) and their associated functionality. Referring to FIG. 3, a block diagram (300) is provided illustrating the tools (152)-(156) and their associated APIs. As shown, a plurality of tools are embedded within the AI platform (305), with the tools including the registration manager (352) associated with API₀ (312), the evaluator (354) associated with API₁ (322), and the director (356) associated with API₂ (332). Each of the APIs may be implemented in one or more languages and interface specifications. API₀ (312) provides functional support to register participating entities into a collaborative relationship and establish a communication protocol among the entities in the topology, an in an embodiment to establish a communication direction among the entities; API₁ (322) provides functional support to address performance of the local machine learning models of the participating entities; and API₂ (332) provides functional support to share an encoder associated with the selectively identified local model with the participating entities. As shown, each of the APIs (312), (322), and (332) are operatively coupled to an API orchestrator (360), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

Referring to FIGS. 4A and 4B, a flow chart (400) is provided to illustrate communication and sharing of models and corresponding encoders with an operatively coupled entity. As shown, a plurality of entities, e.g. client machines, is assigned to the variable X_{Total} (402). In an exemplary embodiment, there is a minimum of two entities in communication with the operatively coupled entity, e.g. server. Each client machine has at least one machine learning model trained with a corresponding encoder and a corresponding data set. In an exemplary embodiment, one or more of the client machines may include two or more machine learning models and corresponding encoders. Each of the models is trained on data provided by the entity, including encoded and un-encoded data. If the entity trains more than one model, the models will differ in the choice of encodings. The encodings satisfy a specific requirement in that they need to be uniquely decodable. Each model associated with each of the client machines and trained with a corresponding encoder and data set is identified (404). The entity counting variable is initialized (406), and an assessment is conducted to identify if entity_{X} has more than one model (408). A negative response to the assessment is followed by passing the model of entity_{X} to the server (410). Conversely, a positive response to assessment is followed by an internal performance evaluation of the models associated with entity_{X} (412). In an exemplary embodiment, the internal evaluation includes an assessment of each of the models associated with entity_{X} on a common test data set (414), e.g. an internal or private data set, identification of the best performing model among these models (416), and passing the identified best performing model, and operationally the associated encodings, to the server (418).

Following either steps (410) or (418), the entity counting variable is incremented (420), and an assessment is conducted to determine if each of the identified entities participating in the federated learning environment has passed a model to the server (422). A negative response to the assessment is followed by a return to step (408), and a positive response to the assessment concludes the initial aspect of the model performance assessment, directed at a selective internal performance assessment. In an embodiment, an entity that does not pass or otherwise share a model to the server is considered a non-participating entity in the federated learning process.

As shown and described in FIG. 1, the server conducts a performance assessment on each of the received models from the respective entities, with the assessment conducted with a common data set. This enables the performance assessment to be uniform, as each model is assessed on the same data set. It is understood that a participating entity may opt out of the federated learning. As such, the quantity of entities operatively coupled to the server may not align with the quantity of models received by the server. The variable Y_{Total} is assigned to the quantity of models received by the server (424), and it is determined if the variable Y_{Total} exceeds the integer one (426). A negative response is an indication that only one entity is participating in the federated learning, and the process is brought to a conclusion. A positive response to the determination at step (426) is followed by performance data, also referred to herein as test data, being provided or otherwise identified and the server applying the performance data to each of the models, e.g. model_{Y}, (428). There are different protocols for the federated learning. In the embodiment shown and described herein, the server identifies the model with the best performance output from the test data and distributes the corresponding encoder, and optionally the corresponding model, to each of the entities participating in the federated learning (430). Thereafter, each of the participating entities in communication with the server trains their internal entity model(s) on the received encoder and shares their trained model(s) with the federated learning server (432). The federated learning server merges the trained models to create a single shared model that is then communicated to each of the participating entities in the collaborative topology (434). Accordingly, in the embodiment shown and described, the federated learning process evaluates each entity participating model on select and common test data.

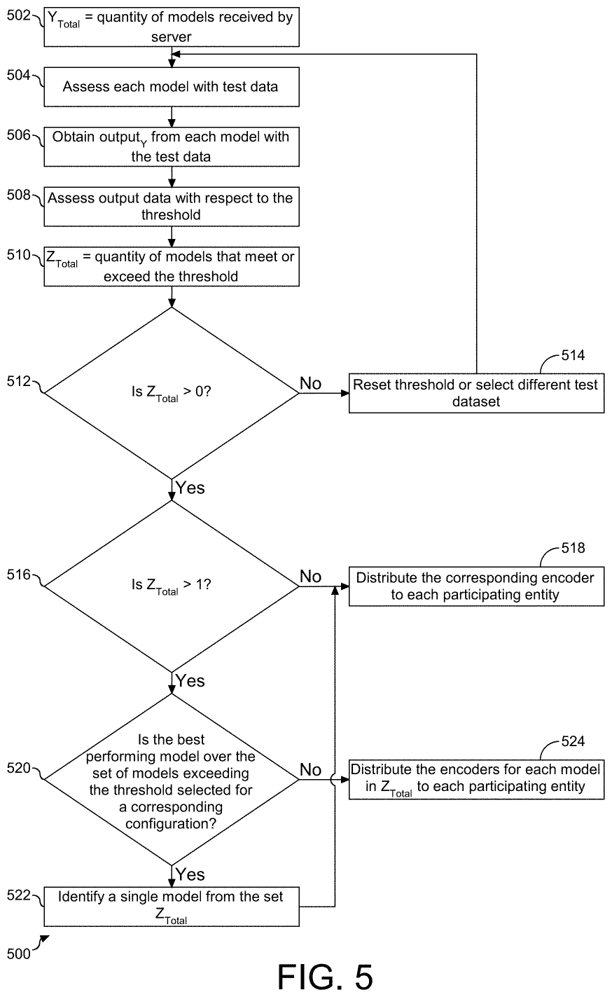

Referring to FIG. 5, a flow chart (500) is provided to illustrate a process for selection of two or more encoders based on the performance assessment from the test data. The process shown herein continues from step (422) in FIG. 4A. Application of the performance data results in performance output data. As shown and described herein, a threshold setting is employed to evaluate output from the performance assessment. In an exemplary embodiment, the threshold is configurable. The variable Y_{Total} is assigned to the quantity of models received by the server (502). Each of the models is assessed by the server with performance data, also referred to herein as test data, (504). In an exemplary embodiment, the performance data is the same for each of the models so that the comparison is uniform or relatively uniform. Output data, referred to herein as output_{Y}, corresponding to model performance is obtained from each of the models with the assessed test data (506). The output data is assessed with respect to the threshold (508), the model(s) with performance that meets or exceeds the threshold are identified and the variable Z_{Total} is assigned to the quantity of models with performance that meets or exceeds the threshold (510). Accordingly, the initial encoder selection process is directed at evaluating model performance against a defined test data set.

After the initial evaluation aspect is completed, it is determined if at least one model has been identified, e.g. if the variable Z_{Total} is greater than zero, (512). A negative response to the determination at step (512) is followed by resetting the threshold or selecting a different test data set (514), or in an embodiment, both resetting the threshold and selecting a different test data set, and returning to step (504). Alternatively, a positive response to the determination at step (512) is followed by an assessment to determine if at least two models have been identified, e.g. if the variable Z_{Total} is greater than one, (516). A negative response to this determination is an indication that only one model has been identified as at least meeting the performance threshold, and the server distributes the corresponding encoder, and optionally the corresponding model, to each of the entities participating in the federated learning (518). A positive response to the determination at step (516) is followed by a subsequent assessment to ascertain if an optimally performing model over the set of models, e.g. Z_{Total}, exceeds the performance threshold selected for a corresponding configuration (520). In an exemplary embodiment, the federated learning configuration is configurable, and as such may not be a static configuration. A positive response to the determination at step (520) is followed by identifying a single model from the set of models Z_{Total} (522), and a return to step (518). As shown herein a negative response to the determination at step (520) is followed by distributing the corresponding encoder for each of the models represented in the set Z_{Total}, and optionally the corresponding model, to each of the entities participating in the federated learning (524). Accordingly, a threshold may be utilized to identify the encoders and corresponding models for use in the federated learning.

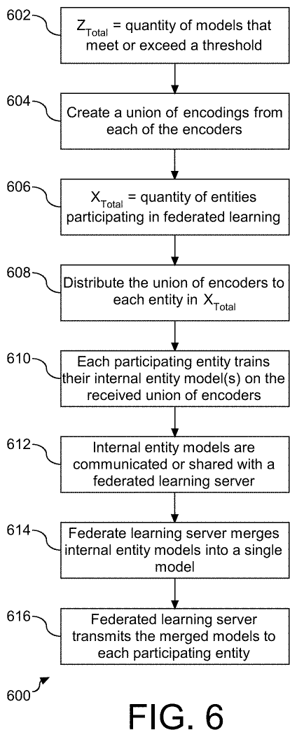

Referring to FIG. 6, a flow chart (600) is provided to illustrate a process for creating a union of encoders for use in the federated learning. The union of encoders is directed at identification of two or more models with performance data that meets or exceeds the threshold. As shown and described in FIG. 5, the variable Z_{Total} represents the models with assessed performance data that meets or exceeds a threshold (602). In the embodiment shown and described in this figure, the variable Z_{Total} represents at least two models. Each model has a corresponding encoder. The server creates a union of the received encodings from each of the encoders, e.g. from Z=1 to Z_{Total}, (604). The variable X_{Total} is assigned to the quantity of entities operatively coupled to the server and participating in the federated learning (606), which in an exemplary embodiment may or may not be equal to the quantity of models. The union of encoders is distributed to each of the entities X_{Total} (608). In an embodiment, encoder transmission or communication in the federated learning environment includes the corresponding model. Thereafter, each of the federated learning participating entities, e.g. from X=1 to X_{Total}, in communication with the server trains their internal entity model(s) on the received union of encoders (610). Following the local training with the respective internal data, the internal entity models are communicated or otherwise shared with a federated learning server (612), which merges the internal entity models into a single model (614). After the merging of the models, the federated learning server transmits the merged model to each of the participating entities, e.g. from X=1 to X_{Total}, (616). Accordingly, in the embodiment shown and described, the federated learning process evaluates each entity participating model on select and common test data.

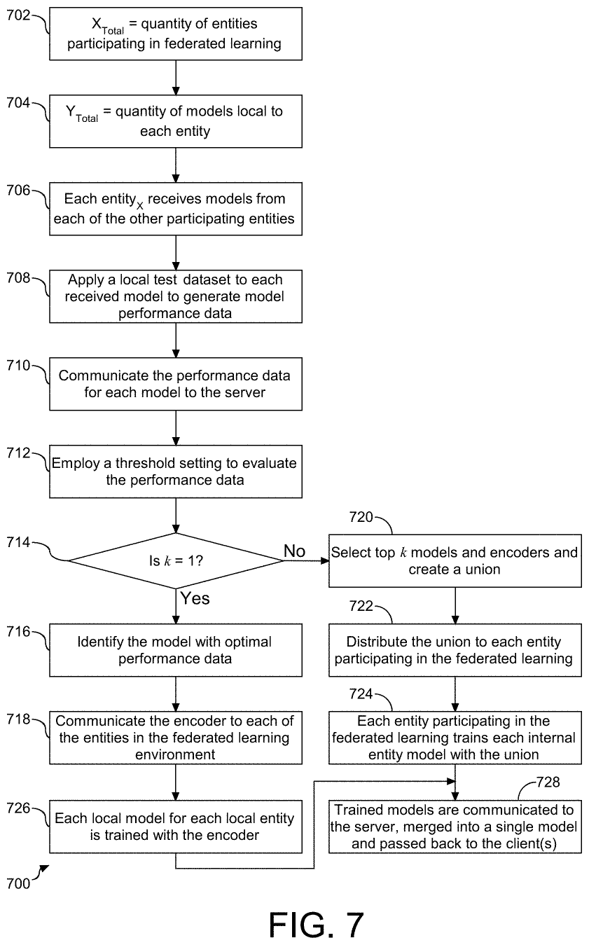

As shown in FIGS. 4A, 4B, 5, and 6, the model assessment is conducted at a selected locale and on a test data set. Referring to FIG. 7, a flow chart (700) is provided to illustrate a process for conducting the assessment in a distributed manner. The variable X_{Total} is assigned to the quantity of entities operatively coupled to the server or a central entity and participating in the federal learning environment (702). It is understood that each participating entity may have a single model, or in an embodiment a plurality of models. For each entity, e.g. entity_{X} for X=1 to X_{Total}, the variable Y_{Total} represents the quantity of models local to each entity (704). Each entity participating in the federal learning conducts a local assessment directed at model performance, with the local assessment utilizing a local test data set, shown herein as testset_{X}. Each entity, e.g. entity_{X} for X=1 to X_{Total}, receives models from each of the other participating entities (706) and applies a local test data set to each of the received models, thereby generating output in the form of model performance data (708). The aspect of receiving models from other entities in the federated leaning environment is limited to the model itself, including the encoder, and no data is moved. The performance data of each assessed model by each entity is communicated to the server or central entity (710). A performance assessment is conducted by the server or central entity using the model performance data results. Accordingly, multiple performance assessments are conducted local to each entity using a test data set local to the respective entity.

Similar to the processes shown and described in FIGS. 4A-6, a threshold setting is employed by the central entity in receipt of each of the model performance data to evaluate output from the performance (712). In addition, a variable, k, is assigned or represents the quantity of models to be employed in conveying corresponding encoders. It is then determined if k is set to the integer one (714). A positive response to the determination is followed by the central entity or server identifying or selecting the model with optimal performance data (716). The central entity or server communicates or otherwise distributes the encoder associated with the identified model, and in an exemplary embodiment the associated model is attached to the encoder, and communicates the encoder and/or model to each of the entities in the federated learning environment (718). Thereafter, local data together with the received encoder are used to train the local model(s) (726). A negative response to the determination at step (714) is followed by the central entity selecting the top k models and associated encoders, and creating a union of the top k models and associated encoders (720). The union of models and encoders is distributed from the central entity to each of the local entities participating in or are members of the federated learning (722). The distribution does not include data, e.g. no data is moved. Thereafter, each of the federated learning participating entities in communication with the server trains each of their internal entity model(s) on the received union of encoders and local data (724). As shown, once the local model(s) are trained with the selected encoder or union of encoders as shown at steps (724) and (726), the local models are passed back to the federated learning server, e.g. server, which aggregates the models to form a single model, and the formed single model is then passed back to the local entities (728). In an exemplary embodiment, the local entities can resume training the formed single model, thereby forming an updated model, and pass or otherwise communicate the updated model to the federated learning server, which can continue the process of aggregating models. In an embodiment, this federated learning process may continue until a performance metric is achieved. Accordingly, in the embodiment shown and described, the federated learning process employs a distributed performance assessment across different test data sets to form a single aggregated model managed by the federated learning server and communicated with the participating entities.

The AI platform with the federal learning environment as shown and described in FIGS. 1-7, are directed at a local entity to server structure or arrangement as shown in FIG. 2. However, the arrangement shown therein should not be considered limiting. In an exemplary embodiment, the arrangement may take different form with different distribution paths, such as a hierarchical structure with layering of the local entities in relation to the central entity.

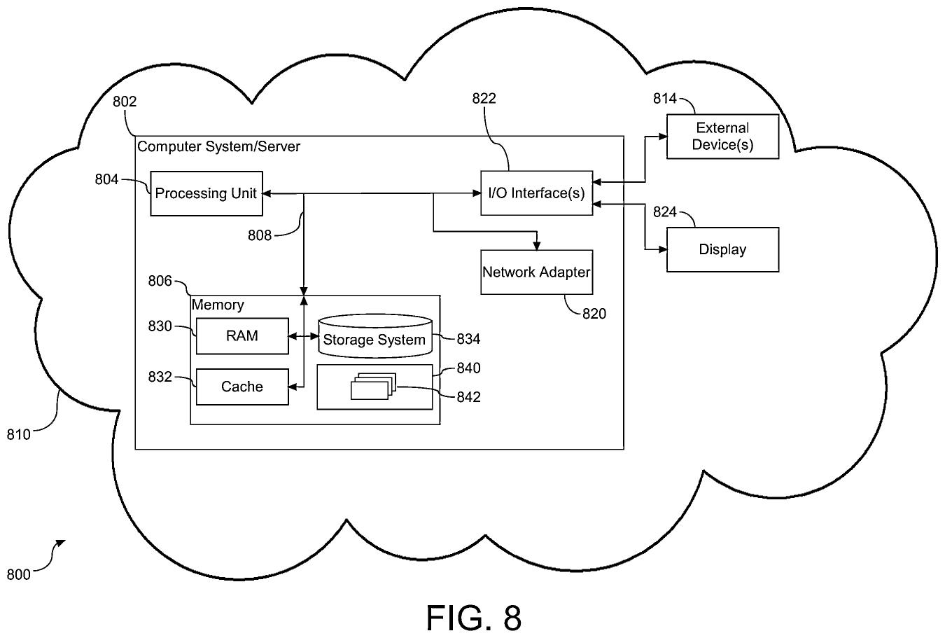

Aspects of the functional tools (152)-(156) and their associated functionality may be embodied in a computer system/server in a single location, or in one embodiment, may be configured in a cloud based system sharing computing resources. With reference to FIG. 8, a block diagram (800) is provided illustrating an example of a computer system/server (802), hereinafter referred to as a host (802) in communication with a cloud based support system, to implement the processes described above with respect to FIGS. 1-7. Host (802) is operational with numerous other general purpose or special purpose computing system environments or configurations. Examples of well-known computing systems, environments, and/or configurations that may be suitable for use with host (802) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (802) may be described in the general context of computer system-executable instructions, such as program modules, being executed by a computer system. Generally, program modules may include routines, programs, objects, components, logic, data structures, and so on that perform particular tasks or implement particular abstract data types. Host (802) may be practiced in distributed cloud computing environments (810) where tasks are performed by remote processing devices that are linked through a communications network. In a distributed cloud computing environment, program modules may be located in both local and remote computer system storage media including memory storage devices.

As shown in FIG. 8, host (802) is shown in the form of a general-purpose computing device. The components of host (802) may include, but are not limited to, one or more processors or processing units (804), e.g. hardware processors, a system memory (806), and a bus (808) that couples various system components including system memory (806) to processor (804). Bus (808) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (802) typically includes a variety of computer system readable media. Such media may be any available media that is accessible by host (802) and it includes both volatile and non-volatile media, removable and non-removable media.

Memory (806) can include computer system readable media in the form of volatile memory, such as random access memory (RAM) (830) and/or cache memory (832). By way of example only, storage system (834) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (808) by one or more data media interfaces.

Program/utility (840), having a set (at least one) of program modules (842), may be stored in memory (806) by way of example, and not limitation, as well as an operating system, one or more application programs, other program modules, and program data. Each of the operating systems, one or more application programs, other program modules, and program data or some combination thereof, may include an implementation of a networking environment. Program modules (842) generally carry out the functions and/or methodologies of embodiments to apply an input encoding method in federated learning. For example, the set of program modules (842) may include the tools (152)-(156) as described in FIG. 1.

Host (802) may also communicate with one or more external devices (814), such as a keyboard, a pointing device, etc.; a display (824); one or more devices that enable a user to interact with host (802); and/or any devices (e.g., network card, modem, etc.) that enable host (802) to communicate with one or more other computing devices. Such communication can occur via Input/Output (I/O) interface(s) (822). Still yet, host (802) can communicate with one or more networks such as a local area network (LAN), a general wide area network (WAN), and/or a public network (e.g., the Internet) via network adapter (820). As depicted, network adapter (820) communicates with the other components of host (802) via bus (808). In one embodiment, a plurality of nodes of a distributed file system (not shown) is in communication with the host (802) via the I/O interface (822) or via the network adapter (820). It should be understood that although not shown, other hardware and/or software components could be used in conjunction with host (802). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (806), including RAM (830), cache (832), and storage system (834), such as a removable storage drive and a hard disk installed in a hard disk drive.

Computer programs (also called computer control logic) are stored in memory (806). Computer programs may also be received via a communication interface, such as network adapter (820). Such computer programs, when run, enable the computer system to perform the features of the present embodiments as discussed herein. In particular, the computer programs, when run, enable the processing unit (804) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (802) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

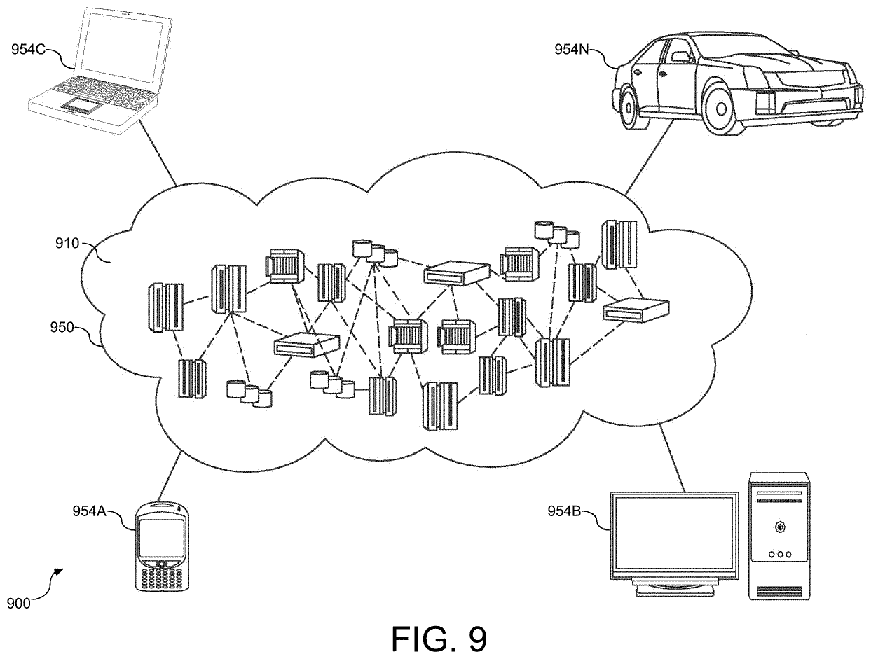

Referring now to FIG. 9, an illustrative cloud computing network (900). As shown, cloud computing network (900) includes a cloud computing environment (950) having one or more cloud computing nodes (910) with which local computing devices used by cloud consumers may communicate. Examples of these local computing devices include, but are not limited to, personal digital assistant (PDA) or cellular telephone (954A), desktop computer (954B), laptop computer (954C), and/or automobile computer system (954N). Individual nodes within nodes (910) may further communicate with one another. They may be grouped (not shown) physically or virtually, in one or more networks, such as Private, Community, Public, or Hybrid clouds as described hereinabove, or a combination thereof. This allows cloud computing environment (900) to offer infrastructure, platforms and/or software as services for which a cloud consumer does not need to maintain resources on a local computing device. It is understood that the types of computing devices (954A-N) shown in FIG. 9 are intended to be illustrative only and that the cloud computing environment (950) can communicate with any type of computerized device over any type of network and/or network addressable connection (e.g., using a web browser).

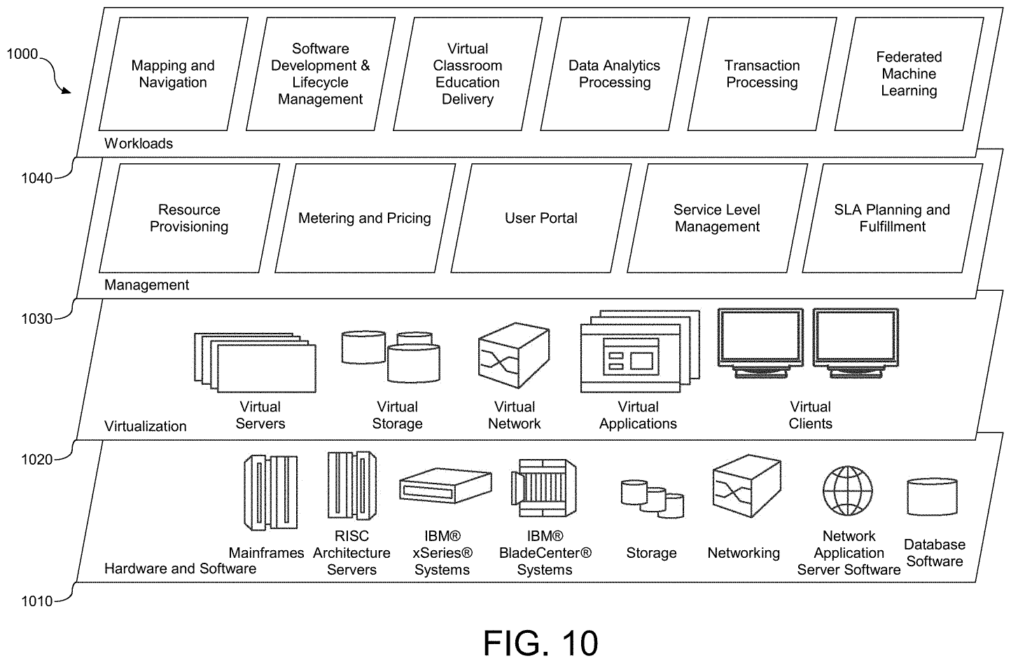

Referring now to FIG. 10, a set of functional abstraction layers (1000) provided by the cloud computing network of FIG. 9 is shown. It should be understood in advance that the components, layers, and functions shown in FIG. 10 are intended to be illustrative only, and the embodiments are not limited thereto. As depicted, the following layers and corresponding functions are provided: hardware and software layer (1010), virtualization layer (1020), management layer (1030), and workload layer (1040).

The hardware and software layer (1010) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1020) provides an abstraction layer from which the following examples of virtual entities may be provided: virtual servers; virtual storage; virtual networks, including virtual private networks; virtual applications and operating systems; and virtual clients.

In one example, management layer (1030) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (1040) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and federated machine learning.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to improve the functionality and operation of an artificial intelligence platform to apply an input-encoding technique in federated learning to enable training of a model with a common encoder.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A system comprising:
a processing unit operatively coupled to memory;
an artificial intelligence (AI) platform in communication with the processing unit, the AI platform to apply input encodings in federated learning, the AI platform comprising:
a registration manager configured to arrange at least first and second participating entities in a collaborative relationship, the first participating entity training a first machine learning model with a first encoder on a first training data set to produce first encoded features and the second participating entity training a second machine learning model with a second encoder on a second training data set to produce second encoded features;
an evaluator, operatively coupled to the registration manager, configured to:
measure performance of the first and second machine learning models; and
selectively identify at least one of the first and second machine learning models based on the measured performance; and
a director, operatively coupled to the evaluator, configured to share an encoder of the selectively identified machine learning model with each of the participating entities, the shared encoder configured to be applied by the first and second participating entities to train the first and second machine learning models, respectively, and configured to be merged into a single shared model.

2. The computer system of claim 1, wherein at least the first participating entity trains at least two machine learning models, each of the two machine learning models having a separate encoder and a separate training data set, and further comprising the evaluator configured to measure performance of the at least two machine learning models on first test data, and selectively identify and share with an entity operatively coupled to the first and second participating entities one of the at least two machine learning models based on their measured performance.

3. The computer system of claim 1, further comprising the evaluator configured to test combinations of the first and second machine learning models, and wherein the selective identification includes a combination of the first and second encoders.

4. The computer system of claim 3, further comprising the evaluator configured to create a union of the first and second encoders and share the union with the participating entities.

5. The computer system of claim 1, further comprising:
the evaluator configured to share the first and second machine learning models with each of the first and second entities;
the first entity to evaluate the first and second machine learning models with first test data and measure first performance of the first and second models based on the first test data;
the second entity to evaluate the first and second machine learning models with second test data, different from the first test data, and measure second performance of the first and second models based on the second test data;
the first and second entities to share the first and second measured performance data with the evaluator; and
the evaluator to selectively identify one or more of the first and second models.

6. The computer system of claim 1, further comprising the director configured to merge the trained first and second machine learning models and form a single machine learning model.

7. A computer program product to apply input encodings in federated learning, the computer program product comprising a computer readable storage medium having program code embodied therewith, the program code executable by a processor configured to:
arrange at least first and second participating entities in a collaborative relationship to train a machine learning model, the first participating entity training a first machine learning model with a first encoder on a first training data set to produce first encoded features and the second participating entity training a second machine learning model with a second encoder on a second training data set to produce second encoded features;
evaluate, by an entity operatively coupled to the first and second participating entities, the first and second machine learning models, including:
measure performance of the first and second machine learning models; and
selectively identify at least one of the first and second machine learning models based on the measured performance; and
share an encoder of the selectively identified machine learning model with each of the participating entities, the shared encoder configured to be applied by the first and second participating entities to train the first and second machine learning models, respectively, and configured to be merged into a single shared model.

8. The computer program product of claim 7, wherein at least the first participating entity trains at least two machine learning models, each of the two machine learning models having a separate encoder and a separate training data set, and further comprising program code to evaluate performance of the at least two machine learning models on first test data, and selectively identify and share with the entity one of the at least two machine learning models based on their measured performance.

9. The computer program product of claim 7, further comprising program code configured to test combinations of the first and second machine learning models, and wherein the selective identification includes a combination of the first and second encoders.

10. The computer program product of claim 9, further comprising program code configured to create a union of the first and second encoders and share the union with the participating entities.

11. The computer program product of claim 7, further comprising program code configured to:
share the first and second machine learning models with each of the first and second entities;
evaluate, by the first entity, the first and second machine learning models with first test data and measure first performance of the first and second models based on the first test data;
evaluate, by the second entity, the first and second machine learning models with second test data, different from the first test data, and measure second performance of the first and second models based on the second test data;
share, by the first and second entities, the first and second measured performance data with the entity; and
selectively identify, by the entity, one or more of the first and second models.

12. The computer program product of claim 7, further comprising program code configured to merge the trained first and second machine learning models and form a single machine learning model.

13. A method comprising:
arranging at least first and second participating entities in a collaborative relationship to train a machine learning model, the first participating entity training a first machine learning model with a first encoder on a first training data set producing first encoded features and the second participating entity training a second machine learning model with a second encoder on a second training data set producing second encoded features;
evaluating, by an entity operatively coupled to the first and second participating entities, the first and second machine learning models, including:
measuring performance of the first and second machine learning models; and
selectively identifying at least one of the evaluated first and second machine learning models based on the measured performance; and
sharing an encoder of the selectively identified machine learning model with each of the participating entities, the shared encoder configured to be applied by the first and second participating entities to train the first and second machine learning models, respectively, and configured to be merged into a single shared model.

14. The method of claim 13, wherein at least the first participating entity trains at least two machine learning models, each of the two machine learning models having a separate encoder and a separate training data set, and further comprising the first entity evaluating performance of the at least two machine learning models on first test data, and selectively identifying and sharing with the entity one of the at least two machine learning models based on their measured performance.

15. The method of claim 13, wherein the evaluating further comprises the entity testing combinations of the first and second machine learning models, and wherein the selective identification includes a combination of the first and second encoders.

16. The method of claim 15, further comprising creating a union of the first and second encoders and sharing the union with the participating entities.

17. The method of claim 13, further comprising:
sharing the first and second machine learning models with each of the first and second entities;
the first entity evaluating the first and second machine learning models with first test data and measuring first performance of the first and second models based on the first test data;
the second entity evaluating the first and second machine learning models with second test data, different from the first test data, and measuring second performance of the first and second models based on the second test data;
the first and second entities sharing the first and second measured performance data with the entity; and
the entity selectively identifying one or more of the first and second models.

18. The method of claim 13, further comprising merging the trained first and second machine learning models and forming a single machine learning model.
